(19) United States
(12) Patent Application Publication
(10) Pub. No.: US 2025/0303888 A1
(43) Pub. Date: Oct. 2, 2025

(54) CONTACTLESS ELECTRIC POWER TRANSMISSION SYSTEM, MOVABLE BODY, AND CONTACTLESS ELECTRIC POWER TRANSMISSION METHOD

(71) Applicant: HONDA MOTOR CO., LTD., Tokyo (JP)

(72) Inventor: Shuji Kawano, Wako-shi (JP)

(21) Appl. No.: 19/064,805

(22) Filed: Feb. 27, 2025

(30) Foreign Application Priority Data
Mar. 27, 2024 (JP) 2024-051503

(51) Int. Cl. B60L 53/126; B60L 53/39; B60L 53/66; H02J 50/12; H02J 50/90

(52) U.S. Cl. CPC B60L 53/126; B60L 53/39; B60L 53/66; H02J 50/12; H02J 50/90

(57) ABSTRACT

A contactless electric power transmission system of an embodiment is a contactless electric power transmission system that supplies electric power in a contactless manner from an electric power supply device provided on a movement path of a movable body to an electric power reception device provided on the movable body, wherein the electric power reception device includes: a control portion that transmits a pairing signal to the electric power supply device from the electric power reception device when the time or the distance in accordance with the position of the movable body and the installation position of the electric power supply device is less than a threshold value, and shifts the operation mode of the electric power reception device to an electric power reception mode when a reply to the pairing signal from the electric power supply device is obtained.

### CROSS-REFERENCE TO RELATED APPLICATION

Priority is claimed on Japanese Patent Application No. 2024-051503, filed on Mar. 27, 2024, the contents of which are incorporated herein by reference.

### BACKGROUND

### Field of the Invention

The present invention relates to a contactless electric power transmission system, a movable body, and a contactless electric power transmission method.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted. In this context, in a contactless electric power transmission system that supplies electric power to a vehicle from the outside of the vehicle, a technique is known in which communication between an electric power transmission side and an electric power reception side is performed by superimposing a communication signal on an electric power supply signal transmitted from the electric power transmission side to the electric power reception side (for example, refer to Japanese Unexamined Patent Application, First Publication No. 2013-247807 and Japanese Patent No. 5348325).

### SUMMARY

In techniques relating to charging and electric power supply in a vehicle on which a secondary battery is mounted, there is a problem that the distance between the electric power transmission side and the electric power reception side is changed when a movable body such as a vehicle is moving, and therefore, it may not be possible to perform appropriate electric power transmission.

The present application aims at providing a contactless electric power transmission system, a movable body, and a contactless electric power transmission method capable of realizing a control of further appropriate electric power transmission even when a movable body is moving. Further, the present application contributes to energy efficiency.

A contactless electric power transmission system according to a first aspect of the present invention is a contactless electric power transmission system that supplies electric power in a contactless manner from an electric power supply device provided on a movement path of a movable body to an electric power reception device provided on the movable body, wherein the electric power reception device includes: a control portion that transmits a pairing signal to the electric power supply device from the electric power reception device when the time or the distance in accordance with the position of the movable body and the installation position of the electric power supply device is less than a threshold value, and shifts the operation mode of the electric power reception device to an electric power reception mode when a reply to the pairing signal from the electric power supply device is obtained.

A second aspect is the contactless electric power transmission system according to the first aspect described above which may further include: a position detection portion that detects a position of the electric power supply device which is present in a traveling direction of the movable body based on the position of the movable body and map information and/or detects the position of the electric power supply device based on an analysis result of an image captured by a camera mounted on the movable body, wherein the control portion may transmit the pairing signal when a distance to the position corresponding to the installation position of the electric power supply device detected by the position detection portion is less than a predetermined distance.

A third aspect is the contactless electric power transmission system according to the first aspect described above which may further include: a position detection portion that detects a position of the electric power supply device which is present in a traveling direction of the movable body based on the position of the movable body and map information and/or detects the position of the electric power supply device based on an analysis result of an image captured by a camera mounted on the movable body, wherein the control portion may transmit the pairing signal when a time until the movable body arrives at the electric power supply device detected by the position detection portion is less than a predetermined time.

A fourth aspect is the contactless electric power transmission system according to the first aspect described above, wherein the control portion may transmit the pairing signal from the electric power reception device to the electric power supply device when being in a weak coupling state coupled with the electric power supply device by a weak magnetic field in a predetermined range.

A movable body according to a fifth aspect of the present invention is a movable body on which an electric power reception device that receives electric power in a contactless manner from an electric power supply device provided on a movement path is mounted, the movable body including: a control portion that transmits a pairing signal to the electric power supply device from the electric power reception device when the time or the distance in accordance with the position of the movable body and the installation position of the electric power supply device is less than a threshold value, and shifts the operation mode of the electric power reception device to an electric power reception mode when a reply to the pairing signal from the electric power supply device is obtained.

A contactless electric power transmission method according to a sixth aspect of the present invention is a contactless electric power transmission method that supplies electric power in a contactless manner from an electric power supply device provided on a movement path of a movable body to an electric power reception device provided on the movable body, the contactless electric power transmission method including: by way of the electric power reception device, transmitting a pairing signal to the electric power supply device from the electric power reception device when the time or the distance in accordance with the position of the movable body and the installation position of the electric power supply device is less than a threshold value; and shifting an operation mode of the electric power reception device to an electric power reception mode when a reply to the pairing signal from the electric power supply device is obtained.

According to the first to sixth aspects described above, it is possible to realize a control of further appropriate electric power transmission even when a movable body is moving.

### BRIEF DESCRIPTION OF THE DRAWINGS

FIG. 1 is a schematic configuration view of a contactless electric power transmission system according to an embodiment.

FIG. 2 is a view showing an example of the configuration of an electric power supply device of the embodiment.

FIG. 3 is a view showing an example of the configuration of a vehicle of the embodiment.

FIG. 4 is a view showing a transition of an operation mode.

FIG. 5 is a view showing a relationship between a coupling state and a distance.

FIG. 6 is a view showing an example of a bit layout of pairing information in the embodiment.

FIG. 7 is a flowchart showing an example of a contactless electric power transmission process in the embodiment.

FIG. 8 is a view showing detection of the electric power supply device provided on a road.

FIG. 9 is a view showing a state in which a plurality of electric power supply devices are arranged.

FIG. 10 is a flowchart showing another example (part 1) of a contactless electric power transmission process.

FIG. 11 is a flowchart showing another example (part 2) of a contactless electric power transmission process.

### DESCRIPTION OF EMBODIMENTS

Hereinafter, a contactless electric power transmission system, a movable body, and a contactless electric power transmission method according to an embodiment of the present invention will be described with reference to the drawings.

### System Configuration

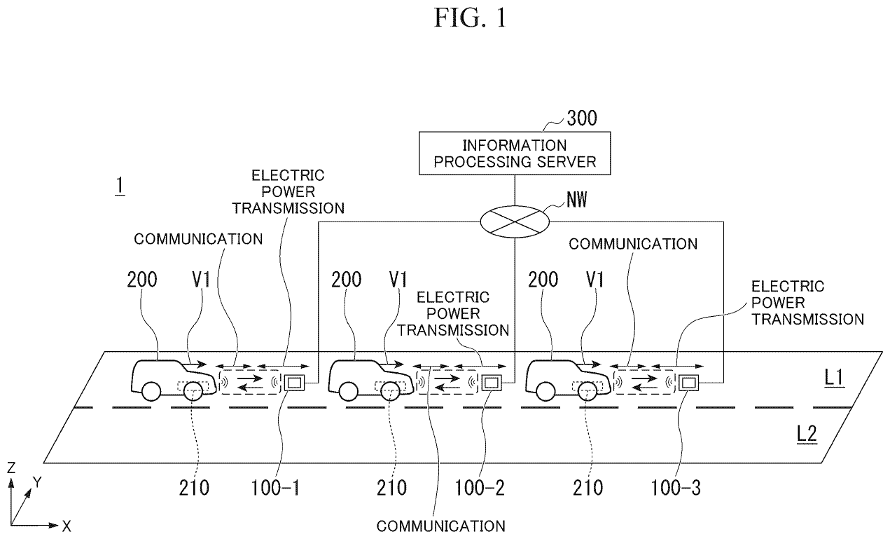

FIG. 1 is a schematic configuration view of a contactless electric power transmission system according to an embodiment. A contactless electric power transmission system 1 according to the embodiment includes, for example, an electric power supply device 100, a vehicle 200 which is an example of a movable body, and an information processing server 300. The electric power supply device 100 and the information processing server 300 communicate with each other, for example, via a network NW. The network NW includes, for example, the Internet, a WAN (Wide Area

Network), a LAN (Local Area Network), a cellular network, a public line, a provider device, a wireless base station, and the like. In the contactless electric power transmission system 1, the vehicle 200 may also communicate with the information processing server 300 via the network NW using a communication device mounted on the vehicle 200. Further, in the contactless electric power transmission system 1, the electric power supply device 100 and the vehicle 200 communicate with each other using other communication means described later. Further, in the contactless electric power transmission system 1, the vehicle 200 is, for example, an electric vehicle such as an electric automobile, a hybrid vehicle, a fuel cell vehicle, and the like. The movable body of the embodiment may be an object that is movable on a movement path such as an electric robot other than the vehicle 200. Further, the movable body may carry or may not carry a person on board. Further, the movable body may include a configuration capable of performing not only manual driving by an occupant (driver) but also automatic driving. In the following description, the movable body is a vehicle.

The contactless electric power transmission system 1 supplies electric power from the electric power supply device 100 to the vehicle 200 by contactless electric power transmission between the electric power supply device 100 and the vehicle 200. In the contactless electric power transmission system 1, the electric power supply device 100 supplies electric power to a plurality of vehicles 200, and the vehicle 200 receives electric power from a plurality of electric power supply devices 100. However, for convenience of explanation, one-to-one contactless electric power supply is mainly described.

The electric power supply device 100 is installed (buried), for example, at a predetermined interval on a road surface of a predetermined electric power supply lane (for example, a lane L1) among lanes L1 and L2 (an example of a movement path) on which the vehicle 200 can travel (for example, electric power supply devices 100-1, 100-2, 100-3 and the like shown in FIG. 1).

The predetermined interval is, for example, an interval at which magnetic field coupling regions of the electric power supply devices 100 do not overlap with each other. Further, the predetermined interval may be set in accordance with a road type (for example, a general road or an expressway) or may be set in accordance with the traffic regulation such as the speed limit of the road. For example, the electric power supply device 100 communicates with the vehicle 200 that approaches within a predetermined distance and supplies electric power in response to an electric power supply request from the vehicle 200. Further, the electric power supply device 100 performs a process related to an electric power protection function (for example, a FSA (Fail Safe Action)) and an electric power control in response to a request.

An electric power reception device 210 is provided on the vehicle 200. The electric power reception device 210 is provided on a bottom portion of the vehicle 200 so as to easily receive electric power and the like from the electric power supply device provided on a road surface; however, the installation position is not limited thereto. The electric power reception device 210 performs a process related to, for example, the vehicle energy management and the electric power protection function (for example, FSA). Further, the vehicle 200 travels using electric power charged in an electric power storage portion such as a mounted battery or supplies electric power to other in-vehicle devices. Further, the vehicle 200 communicates with the electric power supply devices 100-1 to 100-3 while traveling on the electric power supply lane (lane L1), and charges the electric power storage portion mounted on the vehicle 200 using the electric power supplied in response to a request. In the contactless electric power transmission system 1, a communication system required between the electric power supply device 100 and the vehicle 200 is a system that can at least individually identify the vehicle 200 and can communicate with the vehicle 200 in a state where the vehicle 200 is moving at a speed V1 of about 0 to 100 [km/h]. Details of the functional configurations of the electric power supply device 100 and the vehicle 200 will be described later.

The information processing server 300 may be, for example, a server device or a PC (Personal Computer) or may be a cloud server or the like constituted of cloud computing including one or more information processing devices. The information processing server 300 communicates with the electric power supply device 100, the vehicle 200, and the like and performs various processes and the like related to electric power. The information processing server 300 may be, for example, a billing system related to contactless electric power supply, may be an electricity bidding system, or may be a system linked to these systems. The billing system is, for example, a system for individually identifying the vehicle 200 and collecting a fee in accordance with the charged electric power. The electricity bidding system performs, for example, various controls and management to conduct low-cost electricity bidding and the like based on demand forecasts.

Further, the information processing server 300 manages the state of the electric power supply device 100, accumulates the electric power supplied from each of the electric power supply devices 100-1 to 100-3 to the vehicle 200, and performs calculation, management, and the like of the actual electric power transmitted to each vehicle 200.

### Electric Power Supply Device

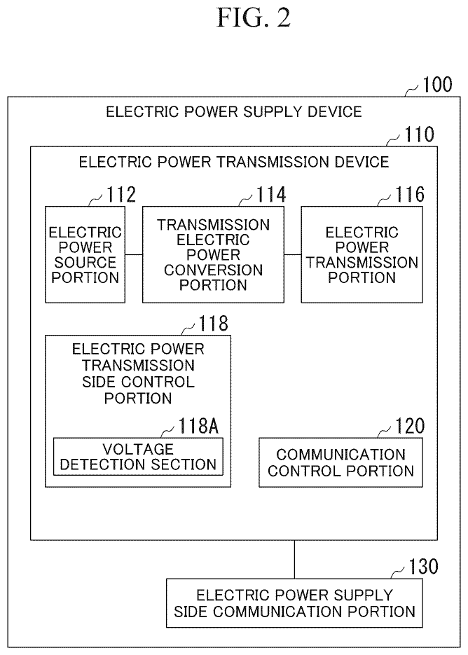

FIG. 2 is a view showing an example of a configuration of the electric power supply device 100 of the embodiment. The electric power supply device 100 includes, for example, an electric power transmission device 110 and an electric power supply side communication portion 130. The electric power transmission device 110 includes, for example, an electric power source portion 112, a transmission electric power conversion portion 114, an electric power transmission portion 116, an electric power transmission side control portion (an example of an electric power supply side control portion) 118, and a communication control portion 120. The electric power transmission side control portion 118 includes a voltage detection section 118A. Some or all of the electric power transmission side control portion 118 and the communication control portion 120 are realized by, for example, a hardware processor such as a CPU (Central Processing Unit) executing a program (software). Some or all of these components may be realized by hardware (a circuit portion including circuitry) such as a LSI (Large Scale Integration), an ASIC (Application Specific Integrated Circuit), a FPGA (Field-Programmable Gate Array), a GPU (Graphics Processing Unit), or a SOC (System on Chip), or may be realized by cooperation of software and hardware. The program may be stored in advance in a storage device (a storage device including a non-transitory storage medium) such as a HDD (Hard Disk Drive) or a flash memory of the electric power supply device 100, or may be stored in a removable storage medium such as a DVD or a CD-ROM and be installed in the HDD or the flash memory of the electric power supply device 100 by attaching the storage medium (non-transitory storage medium) to a drive device.

The electric power source portion 112 of the electric power transmission device 110 is connected to the transmission electric power conversion portion 114. The electric power source portion 112 includes, for example, an AC electric power source such as a commercial electric power source, an AC-DC converter that converts AC electric power into DC electric power, and a capacitor for smoothing of electric power. The electric power source portion 112 converts, for example, AC electric power supplied from the AC electric power source into DC electric power by the AC-DC converter. Further, the electric power source portion 112 performs a smoothing process of electric power by the capacitor at the time of electric power conversion.

The transmission electric power conversion portion 114 is connected to the electric power transmission portion 116. The transmission electric power conversion portion 114 includes, for example, an inverter that converts DC electric power into AC electric power. The inverter includes, for example, a bridge circuit formed of a plurality of switching elements and rectifying elements that are connected by bridge connection in two phases and a resonance capacitor for resonance adjustment of a coil. Details of a circuit configuration of the transmission electric power conversion portion 114 will be described later.

The electric power transmission portion 116 transmits electric power to the outside (for example, the electric power reception device 210 of the vehicle 200) by the change of a high-frequency magnetic field, for example, using magnetic field coupling by magnetic field resonance. In the magnetic field resonance, for example, when a current flows through a coil on the electric power transmission side, a magnetic field oscillation occurs, and this oscillation is transmitted to a resonant circuit on the electric power reception side which resonates at the same frequency and thereby causes a current to flow. Further, the magnetic field coupling may be achieved by a known coupling method such as electromagnetic induction other than the magnetic field resonance. In the electromagnetic induction, for example, electric power is transmitted by using an induced magnetic flux generated between the electric power transmission side and the electric power reception side.

The electric power transmission side control portion 118 integrally controls each function of the electric power transmission device 110 or the entire electric power supply device 100. For example, the electric power transmission side control portion 118 controls pairing, electric power transmission, and the like based on information (for example, a pairing signal and an electric power reception side operation mode) and the like obtained by the electric power supply side communication portion 130 communicating with a vehicle side communication portion 230 of the vehicle 200. The pairing signal includes, for example, an electric power reception device ID which is identification information for identifying the electric power reception device 210 or a vehicle ID which is identification information for identifying the vehicle 200, and parameter information such as required electric power or a battery voltage.

For example, the electric power transmission side control portion 118 identifies the electric power reception device 210 and the vehicle 200 based on the electric power reception device ID and the vehicle ID, and establishes (completes) pairing. Further, the electric power transmission side control portion 118 may refer to user information or the like registered in advance based on the electric power reception device ID or the vehicle ID, and establish pairing when the vehicle (or user) is capable of receiving electric power (can use an electric power supply service). The electric power transmission side control portion 118 controls electric power transmission so that electric power is supplied to the vehicle 200 with which pairing has been established.

The electric power reception side operation mode is an operation mode of the electric power reception device 210 (described later) mounted on the vehicle 200, and includes, for example, a short mode, a parameter transmission mode, a standby mode, an electric power reception mode, and the like. The short mode is a mode of preventing unexpected electric power reception and is, for example, a mode used in FSA and the like. The parameter transmission mode is a mode of transmitting parameter information. The standby mode is, for example, a mode of waiting for the communication with the electric power supply side.

The electric power reception mode is a mode in which pairing is established and an electric power reception portion 211 and a reception electric power conversion portion 212 wait for electric power reception in an operating state, or in which electric power can be received or is being received based on a predetermined frequency (required frequency for resonance).

Further, the electric power transmission side control portion 118 controls the operation mode (electric power transmission side operation mode) of the electric power transmission device 110 in accordance with the situation. For example, the operation mode includes an off mode, a search mode, a standby mode, an electric power transmission mode, and the like. The off mode in the electric power transmission side operation mode is a mode in which a vehicle that provides service does not exist within the electric power transmission service section (electric road) and the electric power transmission side is not in operation. The search mode is a mode in which pairing with the vehicle 200 is established, the coupling coefficient is increased, a situation in which electric power transmission efficiency can be ensured is detected, and electric power transmission is suspended. The standby mode is, for example, a mode in which communication with the electric power reception side is waited for. The electric power transmission mode is, for example, a state in which electric power can be transmitted based on a required frequency or a state (electric power transmission state) in which electric power is being transmitted.

For example, the electric power transmission side control portion 118 shifts the operation mode of the electric power transmission device 110 from the off mode to the reception (standby) mode at the time when pairing with the vehicle 200 is established. Further, when the electric power transmission side control portion 118 receives information such as a required frequency of electric power transmission from the vehicle 200 from the electric power reception device 210 via the communication control portion 120, the electric power transmission side control portion 118 shifts the operation mode from the reception mode to the search mode. Further, the electric power transmission side control portion 118 shifts to the electric power transmission mode when the electric power transmission efficiency can be ensured in the search mode. The electric power transmission side control portion 118 may perform electric power transmission at a preset drive frequency instead of the required frequency in the electric power transmission state of the electric power transmission mode. The electric power transmission side control portion 118 performs electric power transmission to the electric power reception device 210 of the vehicle 200 by controlling the on (conductive) and off (interrupted) switching of each switching element of the transmission electric power conversion portion 114 in accordance with the required frequency. Further, for example, when electric power transmission to the vehicle 200 side becomes impossible or when communication becomes impossible, the electric power transmission side control portion 118 ends pairing and shifts the electric power transmission device 110 to the off mode.

Further, the electric power transmission side control portion 118 may perform a control relating to billing and settlement in accordance with the used electric power amount [kWh] after using the system on the vehicle 200 side. Further, the voltage detection section 118A of the electric power transmission side control portion 118 detects a voltage in the transmission electric power conversion portion 114. The electric power transmission side control portion 118 acquires information (for example, bit string information) from the vehicle side based on the waveform (for example, rectangular wave) of the detected voltage. Details of this process will be described later. The electric power transmission side control portion 118 performs various controls and the like described above based on various information acquired through communication between the electric power supply side communication portion 130 and the vehicle side communication portion 230, or information acquired based on the voltage waveform.

The communication control portion 120 controls the operation of the electric power supply side communication portion 130. For example, when the electric power supply device 100 includes a plurality of electric power supply side communication portions 130, the communication control portion 120 controls the operations of all electric power supply side communication portions 130. For example, the communication control portion 120 attempts to acquire predetermined information (for example, a pairing signal or information on electric power transmission (for example, a required frequency, information required for billing and settlement after using the system, and the like)) through communication between the electric power supply side communication portion 130 and the vehicle side communication portion 230 of the surrounding vehicle 200 at a timing such as a predetermined period. The communication control portion 120 outputs the acquired information to the electric power transmission side control portion 118, and transmits information (pairing establishment information and information required for starting electric power transmission) acquired from the electric power transmission side control portion 118 and the like to the vehicle side communication portion 230 via the electric power supply side communication portion 130.

The electric power supply side communication portion 130 includes an antenna for wireless communication and the like and communicates wirelessly with an external device (for example, the information processing server 300, the vehicle 200). Further, for example, the electric power supply side communication portion 130 transmits and receives information and the like on electric power transmission from the electric power transmission device 110 to the vehicle 200. Specifically, the electric power supply side communication portion 130 transmits and receives information for pairing with the vehicle 200 side so that electric power is supplied to a specific vehicle 200 by the control of the electric power transmission side control portion 118 and the communication control portion 120, and transmits and receives information for adjusting the transmitted electric power amount. Further, the electric power supply side communication portion 130 may acquire information from another external device via the network NW.

### Vehicle

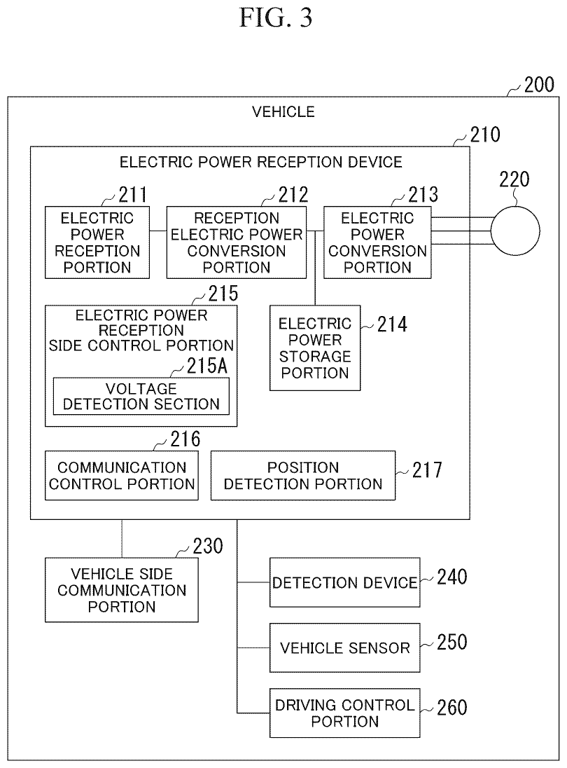

FIG. 3 is a view showing an example of a configuration of the vehicle 200 of the embodiment. The vehicle 200 includes, for example, the electric power reception device 210, a rotary electric machine 220, the vehicle side communication portion 230, a detection device 240, a vehicle sensor 250, and a driving control portion 260. Although not shown in FIG. 1, the vehicle 200 includes, for example, various in-vehicle devices (examples of a load and an auxiliary machine) such as various devices (a travel control device and the like) for traveling on a road by manual driving by a driver or automatic driving, a car navigation device, and an audio device in addition to the above-described in-vehicle devices. The electric power reception device 210 includes, for example, the electric power reception portion 211, the reception electric power conversion portion 212, an electric power conversion portion 213, an electric power storage portion 214, an electric power reception side control portion 215, a communication control portion 216, and a position detection portion 217. The electric power reception side control portion 215 includes, for example, a voltage detection section 215A. Some or all of the electric power reception side control portion 215, the communication control portion 216, and the position detection portion 217 are realized by, for example, a hardware processor such as a CPU executing a program (software). Some or all of these components may be realized by hardware (a circuit portion including circuitry) such as an LSI, an ASIC, a

FPGA, or a GPU, or may be realized by cooperation of software and hardware. The program may be stored in advance in a storage device (a storage device including a non-transitory storage medium) such as a HDD or a flash memory of the vehicle 200 or the electric power reception device 210, or may be stored in a removable storage medium such as a DVD or a CD-ROM and be installed in the HDD or the flash memory of the vehicle 200 or the electric power reception device 210 by attaching the storage medium (non-transitory storage medium) to a drive device.

The electric power reception portion 211 of the electric power reception device 210 is connected to the reception electric power conversion portion 212. The electric power reception portion 211 receives electric power by the change of a high-frequency magnetic field transmitted from the electric power transmission portion 116, for example, using magnetic field coupling such as magnetic field resonance or electromagnetic induction.

The reception electric power conversion portion 212 is connected to the electric power conversion portion 213. The reception electric power conversion portion 212 includes, for example, an inverter that converts AC electric power into DC electric power and smooths and divides the voltage. The inverter includes, for example, a bridge circuit formed of a plurality of switching elements and rectifying elements that are connected by bridge connection in two phases and a capacitor for voltage smoothing. Details of a circuit configuration of the reception electric power conversion portion 212 will be described later.

For example, the electric power reception device 210 which includes the electric power reception portion 211 and the reception electric power conversion portion 212 receives electric power transmitted from the electric power transmission device 110 by controlling the on (conductive) and off (interrupted) switching of each switching element of the reception electric power conversion portion 212 in accordance with information on the frequency of electric power transmission by the electric power transmission device 110 by the control of the electric power reception side control portion 215.

The electric power conversion portion 213 is connected to the rotary electric machine 220. The electric power conversion portion 213 includes, for example, an electric power converter that performs conversion between DC electric power and AC electric power. The electric power converter includes, for example, an element module and a capacitor for voltage smoothing. Details of a circuit configuration of the electric power conversion portion 213 will be described later.

The rotary electric machine 220 is, for example, a three-phase AC brushless DC motor provided for traveling and driving of a vehicle. The rotary electric machine 220 includes a rotor having a permanent magnet for a field, and a stator having a three-phase stator winding that generates a rotating magnetic field that rotates the rotor. The three-phase stator windings are connected to three-phase AC terminals of the electric power conversion portion 213. The rotary electric machine 220 generates a rotation drive force by performing a power running operation using the electric power supplied from the electric power conversion portion 213. For example, when the rotary electric machine 220 can be connected to a wheel of the vehicle 200, the rotary electric machine 220 generates a travel drive force by performing a power running operation using the electric power supplied from the electric power conversion portion 213. The rotary electric machine 220 may generate electric power by performing a regenerative operation using rotation power input from the wheel side of the vehicle 200. When the rotary electric machine 220 can be connected to an internal combustion engine of the vehicle 200, the rotary electric machine 220 may generate electric power using the power of the internal combustion engine.

The electric power storage portion 214 includes, for example, a battery (an example of a secondary battery) such as a lithium ion battery, a current sensor that detects a current of the battery, a voltage sensor that detects a voltage of the battery, and a temperature sensor that measures a temperature of the battery. In the vehicle 200, the electric power storage portion 214 is connected to the reception electric power conversion portion 212 and the electric power conversion portion 213 described later. For example, by the control of the electric power reception side control portion 215, the electric power storage portion 214 is charged by the electric power from the electric power supply device 100 or the rotary electric machine 220 and supplies the charged electric power to the rotary electric machine 220 and various other in-vehicle devices (a load, an auxiliary machine).

The electric power reception side control portion 215 integrally controls, for example, each function of the electric power reception device 210 or the entire vehicle 200. For example, the electric power reception side control portion 215 generates a control signal indicating the timing of driving each switching element to be on (conductive) and off (interrupted), and generates a gate signal for actually driving each switching element to ON and OFF based on the control signal. For example, the electric power reception side control portion 215 controls the switching of each switching element of the electric power reception device 210 and thereby corrects the power factor or the like of the input voltage and the input current while rectifying the AC electric power received from the electric power transmission device 110 into DC electric power.

Further, the electric power reception side control portion 215 generates predetermined information (for example, a pairing signal and information on electric power transmission) for transmitting electric power from the electric power supply device 100 and transmits the generated signal to the outside from the vehicle side communication portion 230. The electric power reception side control portion 215 may transmit the pairing signal at a predetermined cycle or may transmit the pairing signal at another predetermined timing. Further, when the electric power reception side control portion 215 acquires permission information (pairing completion information) indicating that electric power can be supplied from the electric power supply device 100 side, information required for starting electric power transmission, and the like from the vehicle side communication portion 230, target electric power is acquired by a synchronous rectification operation in which a plurality of switching elements of the electric power reception device 210 are synchronously turned on and off and a short-circuit operation in which a secondary side coil is short-circuited, which will be described later. Further, the electric power reception side control portion 215 controls the current of the electric power transmission device 110 and thereby performs independent electric power control such as stopping of electric power transmission on the side of the electric power reception device 210.

The information on electric power transmission is, for example, information on the required electric power and the required frequency of electric power transmission, the target output (electric power consumption) for fail-safe purposes, and various abnormalities, or the like. The required electric power of electric power transmission is a target value of the electric power that the electric power reception device 210 receives from the electric power transmission device 110, and is set, for example, in accordance with the target drive force of the vehicle 200 or the rotary electric machine 220, the electric power consumption of various auxiliary machines connected to the electric power storage portion 214, the electric power state (SOC: State Of Charge) of the electric power storage portion 214, and the like. The electric power state includes, for example, the remaining capacity, a charging rate, and the like of the electric power storage portion 214. The required frequency of electric power transmission is a frequency required for electric power transmission of the electric power transmission device 110 and is set in accordance with the required electric power. The required frequency is set based on, for example, the minimum ground clearance of the vehicle 200, the mounting layout of the electric power reception device 210 on the vehicle 200, and the like so as to prevent a decrease in the electric power transmission efficiency and the output (electric power). The required frequency may be set, for example, in accordance with the state of electric power transmission between the electric power transmission device 110 and the electric power reception device 210. Further, the information on electric power transmission may include information required for billing and settlement after using the system.

Further, the electric power reception side control portion 215 controls the operation mode of the electric power reception device 210 in accordance with the situation of the vehicle 200. As described above, the operation mode includes the short mode, the parameter transmission mode, the standby mode, and the electric power reception mode. For example, the electric power reception side control portion 215 transmits a pairing signal at a predetermined cycle of about several dozen [μs] to several [ms] or the like, and when receiving a response signal to the pairing signal from the electric power supply device 100, the electric power reception side control portion 215 shifts the operation mode of the electric power reception device 210 from the off mode to the short mode and transmits information such as a required frequency. Further, the electric power reception side control portion 215 shifts from the short mode to the electric power reception mode and starts an electric power reception control for the electric power transmission from the electric power supply device 100 in an electric power transmission zone. Further, when the electric power reception is completed, the electric power reception side control portion 215 shifts the operation mode of the electric power reception device 210 from the electric power reception mode to the off mode.

Further, the voltage detection section 215A of the electric power reception side control portion 215 detects the voltage of the reception electric power conversion portion 212. Further, predetermined information is acquired from the electric power supply device 100 based on the waveform (for example, a square wave) of the detected voltage.

The communication control portion 216 controls the operation of the vehicle side communication portion 230. For example, the communication control portion 216 causes the vehicle side communication portion 230 to transmit predetermined information (for example, parameter information such as a pairing signal) at a timing such as a predetermined cycle. Further, the communication control portion 216 may transmit predetermined information when the position of the vehicle 200 is within a predetermined distance from the installation position (electric power supply zone) of the electric power supply device 100 based on the position of the electric power supply device 100 detected by the position detection portion 217.

Then, when pairing is established, information (for example, the required frequency, information required for billing and settlement after using the system, or the like) on electric power transmission is transmitted to the vehicle side communication portion 230.

The position detection portion 217 detects the position of the electric power supply device 100 based on the surrounding situation of the vehicle 200 detected by the detection device 240, information on the vehicle 200 detected by the vehicle sensor 250, and the like.

The vehicle side communication portion 230 includes an antenna for wireless communication or the like and communicates wirelessly with an external device (for example, the information processing server 300, the electric power supply device 100). Further, for example, the vehicle side communication portion 230 transmits and receives information on electric power transmission from the electric power supply device 100. Specifically, the vehicle side communication portion 230 transmits and receives information for performing the pairing with the side of the electric power supply device 100 so that electric power is supplied from a specific power supply device 100 by the control of the electric power reception side control portion 215, and transmits and receives information for adjusting the transmitted electric power amount or the like. Further, the vehicle side communication portion 230 may acquire information from another external device via the network NW.

The detection device 240 corresponds to various devices that detect the surrounding situation (within a predetermined distance from the vehicle 200) of the vehicle 200. The detection device 240 includes, for example, a camera, a radar device, a LIDAR (Light Detection and Ranging), a sensor fusion device, and the like. Further, the detection device 240 recognizes the type, shape, position (relative position), speed (relative speed), and the like of an object present in the vicinity based on the detection result. The object includes, for example, a travel lane on which the vehicle 200 travels, a road dividing line that divides the travel lane, other road structures (a road sign, a median strip, a curb, a traffic light), and the like in addition to traffic participants such as other vehicles and pedestrians. Further, based on the position information of the vehicle 200 detected by the vehicle sensor 250, the detection device 240 may refer to map information or the like stored in a storage portion (not shown) in the vehicle 200 and recognize the surrounding road shapes and the like (for example, the position of the road dividing line), the electric power supply lane, the position of the electric power supply device 100, and the like from the position of the vehicle 200. The map information is, for example, information in which the shape of a movement path is expressed by a link indicating a movement path such as a road in association with the position information (for example, the latitude and the longitude) and a node connected by the link. Further, the map information may include POI (Point Of Interest) information associated with the curvature or the gradient of the movement path and the position information and the like. Further, the map information may include information on the position and the installation zone of the electric power supply device 100 or the electric power transmission device 110 provided in a predetermined area such as a road (movement path) or a parking lot, identification information (electric power supply device ID) of the electric power supply device 100, and information on the identification information (electric power supply zone ID) of the installation zone.

The vehicle sensor 250 includes, for example, a speed sensor that detects the speed V1 of the vehicle 200, an acceleration sensor that detects the acceleration, a yaw rate sensor that detects the yaw rate (angular velocity), a direction sensor that detects the direction of the front direction of the vehicle 200, an operation amount detection sensor attached to a drive operator, and the like. The drive operator includes, for example, an operator (for example, an accelerator pedal and a brake pedal) for instructing acceleration/deceleration and an operator (for example, a steering wheel) for instructing steering. In this case, the vehicle sensor 250 may include an accelerator opening sensor, a brake depression sensor, a steering torque sensor, and the like. Further, a position sensor that detects the position of the vehicle 200 may be provided on the vehicle sensor 250. The position sensor is, for example, a sensor that acquires position information (longitude and latitude information) from a GPS (Global Positioning System) device. Further, the position sensor may be a sensor that acquires position information by using a GNSS (Global Navigation Satellite System) receiver.

The position detection portion 217 described above detects the position of the electric power supply lane or the electric power supply device based on the detection result by the detection device 240. For example, the position detection portion 217 analyzes the surrounding image of the vehicle 200 captured by the camera using a known image analysis process, and detects the position of the electric power supply lane and the position of the electric power supply device 100 from a road sign, a character or a mark drawn on the road, and the like. Further, when the position detection portion 217 acquires the position information of the vehicle using the position sensor or the like mounted on the vehicle 200, the position detection portion 217 acquires the installation position (or electric power supply zone information) of the electric power supply device 100 with reference to map information stored in advance in the storage portion or the like.

The driving control portion 260 controls at least one of the steering and the speed of the vehicle 200 based on the surrounding situation detected by the detection device 240, the information detected by the vehicle sensor 250, and the like, and performs driving control. The driving control includes, for example, a LKAS (Lane

Keeping Assistance System) control (lane keeping control) that performs steering control so that the vehicle 200 travels in the center of the travel lane (movement path) (in other words, so as not to deviate from the road dividing line that divides the travel lane). Further, the driving control includes an ACC (Adaptive Cruise Control), which causes the vehicle 200 to travel at a constant speed set in advance and automatically performs acceleration or deceleration when approaching a preceding vehicle by measuring the distance and the speed difference between the preceding vehicle and the vehicle, and an ALC (Auto Lane Changing) control, which executes lane change (steering control) in the instructed direction when an instruction to change the lane of the vehicle 200 is received by the operation of a turn signal switch by the driver.

### Transition of Operation Mode in Contactless Electric Power Supply

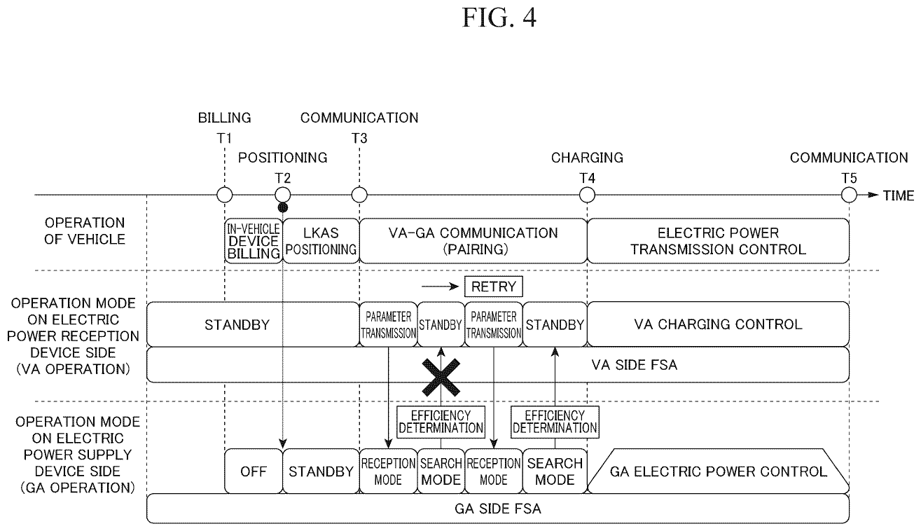

Next, the transition of the operation mode of each of the electric power transmission device 110 and the electric power reception device 210 in the contactless electric power supply is described with reference to the drawings. FIG. 4 is a view showing the transition of an operation mode. In the example of FIG. 4, the horizontal axis indicates time, and the vertical axis indicates an operation of the vehicle 200, an operation mode (VA operation) on the side of the electric power reception device 210, and an operation mode (GA operation) of the electric power supply device 100. The operation transition of FIG. 4 shows an example in which contactless electric power transmission is performed between the electric power supply device 100 and the electric power reception device 210 in a state where the vehicle 200 is traveling at a predetermined speed (for example, about 80 [km/h]) as an example. Hereinafter, the transition in operation over time will be described. In the example of FIG. 4, in the contactless electric power supply, a FSA (Fail Safe Action) is performed in which abnormality detection is constantly performed at the electric power reception device 210 side and the electric power supply device 100 side, and a control to the safe side is performed when an abnormality is detected (VA side FSA, GA side FSA).

At time T1, the electric power reception side control portion 215 of the vehicle 200 communicates with, for example, the information processing server 300 and the like via the vehicle side communication portion 230, and performs a billing process for performing the contactless electric power supply or a pre-process for performing the billing corresponding to the supplied electric power amount (in-vehicle device billing). In a previous step of time T1, the operation mode on the electric power reception device 210 side is the standby mode. Further, during the billing process, the operation mode on the electric power supply device side is the off mode.

At time T2, after the billing process is completed, positioning of the vehicle 200 is performed so that the electric power reception device 210 passes over the electric power supply device 100 installed on the road surface of the road (for example, an electric power supply lane). In this case, the positioning may be performed by the driving control portion 260 based on information detected by the position detection portion 217. Alternatively, an image showing the position (or the position of the electric power supply lane) of the electric power supply device 100 and the current position of the vehicle 200 may be displayed on a display portion (not shown) or the like mounted on the vehicle 200, and the driver may perform the positioning by manual driving while watching the image displayed on the display portion. For example, when the LKAS control is being performed by the driving control portion 260, the vehicle 200 is controlled so as to travel on the middle of the lane, and therefore, by performing the LKAS control and traveling on the electric power supply lane, it is possible to perform the positioning accordingly. During the period from time T2 to time T3, the electric power reception device 210 remains in the short mode, and the electric power supply device 100 shifts from the off mode to the standby (waiting) mode.

At time T3, when the distance between the electric power reception device 210 and the electric power supply device 100 becomes within a predetermined distance (a distance at which communication is possible) due to the traveling of the vehicle 200, the electric power reception side control portion 215 of the vehicle 200 starts pairing between the electric power reception device 210 and the electric power supply device 100 through communication (VA-GA communication). During the period from time T3 to time T4, the electric power reception side control portion 215 alternates between the transmission mode in which parameter information (ID, required electric power, battery voltage, and the like) is transmitted and the standby mode until the efficiency of electric power transmission becomes larger than a predetermined value (for example, larger than 0 [%]). On the other hand, the electric power transmission side control portion 118 of the electric power supply device 100 alternates between the reception mode and the search mode. In the search mode, for example, with respect to correspondence information of the electric power (transmission electric power) and the efficiency of electric power transmission in accordance with the horizontal distance (the relative movement amount between the primary side coil and the secondary side coil in the direction parallel to the road surface) in the contactless electric power transmission system 1 of the embodiment set in advance, the efficiency is acquired from the correspondence information for the electric power obtained by the voltage value and the current value. Further, the electric power transmission side control portion 118 determines the efficiency based on the ratio of the voltage and the current, and when the efficiency is equal to or less than a predetermined value, the electric power transmission side control portion outputs that information to the electric power reception device 210 side to perform a retry operation. That is, in the present embodiment, when the transmission efficiency is not suitable for supplying electric power, the communication on the pairing described above can be performed. For example, when the vehicle 200 is traveling at a speed of 80 [km/h], the expected period (expected communication completion time) from time T3 to time T4 is about 22.5 [msec].

Since the efficiency of the electric power transmission becomes larger than the predetermined value at time T4, the electric power transmission control is performed. For example, the electric power supply device 100 side performs an electric power control (GA electric power control) that transmits electric power corresponding to the required electric power specified by the parameter to the outside. Further, in the electric power reception device 210 side, the electric power transmitted from the electric power supply device 100 is received, and an electric power control (VA charging (electric power reception) control) that stores electric power in the electric power storage portion 214 mounted on the vehicle 200 is performed. That is, the electric power supply device 100 performs communication (pairing communication) with the electric power reception device 210 when the efficiency of the electric power transmission with the electric power reception device 210 is equal to or less than the predetermined value, and performs the electric power supply control for the electric power reception device 210 when the efficiency becomes larger than the predetermined value. Thereby, pairing communication can be completed in a state where the electric power transmission efficiency is not good, and it is possible to further efficiently perform electric power supply in a state where the electric power transmission efficiency is good.

Since the efficiency of the electric power transmission is equal to or less than the predetermined value at time T5, the electric power supply operation is ended at this time. Thereby, it is possible to perform an electric power supply control using efficient electric power transmission. For example, when the vehicle 200 is traveling at 80 [km/h], the expected period (expected electric power transmission time) from time T4 to time T5 is about 18 [msec]. Since the plurality of electric power supply devices 100 are installed at predetermined intervals on the electric power supply lane, the vehicle 200 can be charged up to the required electric power by each electric power supply device 100 performing the control as shown in FIG. 4. Further, at a time point when the electric power supply is completed, the electric power amount up to the time point is accumulated, and a charging process (billing process) or the like for that amount is performed.

In the above process, the case is described in which the vehicle 200 is traveling at a high speed (for example, 80 [km/h]); however, a similar control may be applied at the time of traveling at a low speed or at the time of stopping. That is, the process of the present embodiment is widely applicable, for example, to the situation in which the speed V1 of the vehicle 200 is in the range of 0 to 100 [km/h]. With respect to the electric power supply when the vehicle is stopped, the electric power control is performed by taking into consideration a time rating of, for example, 1, 3, or 10 seconds or the like that is set in advance.

### Pairing by VA-GA Communication

Next, the pairing by VA-GA communication described above is specifically described. In the embodiment, for example, in a state of weak magnetic field coupling (hereinafter, referred to as a weak coupling state), a pairing signal (parameter) is transmitted from the vehicle 200 to the electric power supply device 100, and the electric power reception device 210 is shifted from the standby mode to the electric power reception mode when a reply (for example, the efficiency of the electric power transmission is larger than a predetermined value) indicating that the electric power transmission is started from the electric power supply device 100 is obtained.

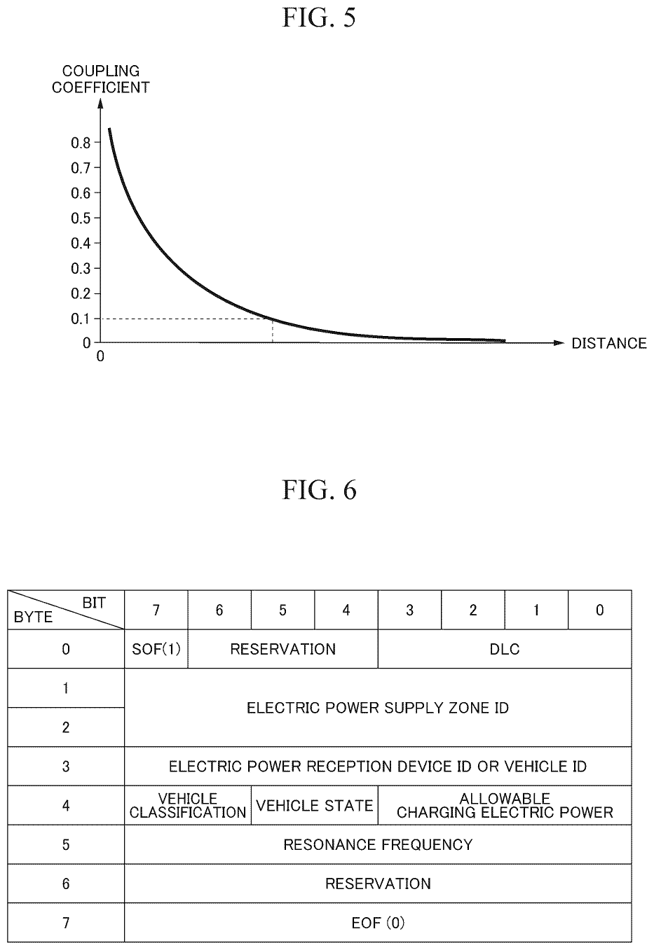

In the embodiment, before the vehicle 200 reaches the electric power supply device 100, when the state becomes a weak coupling state, the communication control portion 216 transmits information (pairing signal) for pairing from the electric power reception device 210 side. FIG. 5 is a view showing a relationship between a coupling state and a distance. In the example of FIG. 5, the horizontal axis represents a distance between the electric power transmission device 110 and the electric power reception device 210, and the vertical axis represents a coupling coefficient (an index value indicating a coupling state such as a strength of the magnetic field coupling) between the electric power transmission side and the electric power reception side.

In the example of FIG. 5, as the distance between the electric power supply side and the electric power reception side is closer, the coupling coefficient becomes larger on a curve. Further, even in a weak coupling state (for example, the coupling coefficient is about 0.1) in which the electric power supply side and the electric power reception side are separated from each other, a current can be induced from the electric power reception device 210 side to the electric power transmission device 110 side. Therefore, the communication control portion 216 transmits information for pairing to the electric power supply device 100 when the vehicle 200 becomes a weak coupling state of a predetermined range (for example, the coupling coefficient is about 0.1 to 0.3) before arriving at the electric power supply device 100.

In this case, for example, by switching a signal (carrier wave) for transmitting electric power in a contactless manner to the electric power transmission device 110 at a predetermined ratio, the communication control portion 216 generates a two-level digital signal of so-called dominant and recessive levels and thereby superimposes the pairing information on the carrier wave. This carrier wave is, for example, a time series waveform of a current measured (induced) at the electric power supply side. The communication control portion 216 can transmit pairing information by amplitude modulation of the carrier by changing the ratio of switching.

The electric power transmission side control portion 118 of the electric power supply device 100 in the embodiment acquires the content of the pairing information by demodulating the current (the carrier wave described above) received by the electric power transmission portion 116.

In the case of the weak coupling state, since there are cases in which the coupling state cannot be maintained due to some factor such as the surrounding environment, it is necessary to shorten the time until the pairing is completed. For example, if the communication completion time in the weak coupling state is 10 [msec], since a current at the time of resonance to the electric power transmission device 110 side is used as a signal, it is necessary to perform transmission at about 85 [kHz], and the transferable signal in that case is about 85 [kbps]. Accordingly, data amount that can be transmitted at 10 [msec] is 850 [bit] in one direction, and when bidirectional transmission and reception of a plurality of times (for example, about three times) are considered, about 8 [byte] can be desirably the upper limit. Therefore, in the embodiment, the data of the pairing information is controlled to be within 8 bytes.

FIG. 6 is a view showing an example of a bit layout of pairing information in the embodiment.

In the example of FIG. 6, the horizontal direction indicates a bit string for each byte, and the vertical direction indicates the position of each byte from 1 to 8. The pairing information in the embodiment may include not only the electric power reception device ID and the vehicle ID but also other information about electric power transmission.

In the pairing information shown in FIG. 6, for example, between a start flag (SOF) of the data and an end flag (EOF), a DLC (Data Length Code), an electric power supply zone ID which is identification information of an electric power reception zone, an electric power reception device ID or a vehicle ID, a vehicle classification (for example, an ordinary vehicle, a truck, a bus, or the like), a vehicle state (for example, whether or not in a state where electric power reception is possible (or a state where electric power reception is required) or the like), allowable charging electric power (for example, target electric power, required electric power), information such as a resonance frequency (required frequency) are stored. The region of “reservation” shown in FIG. 6 may be information stored on the electric power supply device 100 side or may be a backup region. Further, the pairing information may include information of the battery voltage. Further, the type, the order, and the number of bits stored as the pairing signal are not limited to the example of FIG. 6. For example, the data amount can be decreased further than the data amount shown in FIG. 6 by reducing the number of bits of a predetermined item (for example, the electric power supply zone ID) or by reducing the item such as “reservation”. In this way, by storing the information required for the contactless electric power supply within 8 bytes, it is possible to transmit further appropriate information for performing pairing at the time of the weak coupling state.

### Process Flow

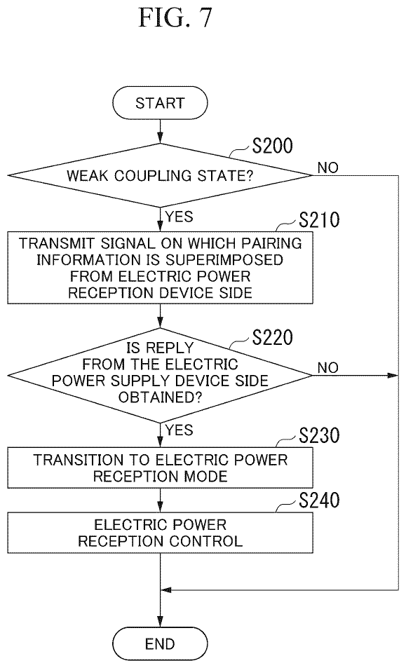

FIG. 7 is a flowchart showing an example of a contactless electric power transmission process in the embodiment. Among various processes performed in the contactless electric power transmission process, the process of FIG. 7 mainly relates to a process of transmitting pairing information and performing an electric power reception control after the pairing. The process of FIG. 7 may be repeatedly performed at a predetermined timing. In the example of FIG. 7, the communication control portion 216 monitors a magnetic field coupling state with the electric power supply device 100 side and determines whether or not the coupling degree is in a weak coupling state within a predetermined range (Step S200). When it is determined that the state is the weak coupling state, the communication control portion 216 transmits a signal (carrier wave) including pairing information from the electric power reception device 210 side to the electric power supply device 100 being coupled (Step S210). Next, the communication control portion 216 determines whether or not a predetermined reply (information indicating that the electric power transmission is started) to the pairing signal is obtained from the electric power supply device 100 side (Step S220). When it is determined that the reply is obtained, the communication control portion 216 shifts the electric power reception device 210 from a sleep mode to the electric power reception mode to be in a state where electric power reception is possible (Step S230) and performs the electric power reception control (Step S240). Thereby, the present flowchart ends. Further, when it is determined that the state is not the weak coupling state in the process of Step S200 or when it is determined that the reply is not obtained from the electric power supply device 100 side in the process of Step S220, the process of the present flowchart ends.

In this way, according to the embodiment, the contactless electric power transmission system 1 supplies electric power in a contactless manner from the electric power supply device 100 provided on the movement path of the vehicle 200 (an example of a movable body) to the electric power reception device 210 provided on the vehicle 200, wherein the electric power reception device 210 includes the communication control portion 216 that transmits pairing information from the electric power reception device 210 to the electric power supply device 100 when being in a weak coupling state with the electric power supply device 100 and shifts the operation mode of the electric power reception device 210 to the electric power reception mode when a reply from the electric power supply device 100 is obtained. Thereby, it is possible to realize a control of further appropriate electric power transmission even when the vehicle 200 is moving. Further, according to the embodiment, it is possible to reliably perform pairing at a higher speed. Further, according to the embodiment, the information for the pairing from the VA side can be implemented using the frequency for electric power transmission by utilizing the weak magnetic field coupling between the VA (electric power reception device 210) and the GA (electric power supply device 100).

Further, according to the embodiment, for example, since the electric power transmission side coil on the electric power supply device 100 side can be used as a communication function for transmitting the pairing information, it is possible to eliminate the need for functions of the communication control portion 120, the electric power supply side communication portion 130, the vehicle side communication portion 230, and the like. Therefore, it is possible to reduce costs of the electric power supply device 100 and the vehicle 200.

### Transmission Timing of Pairing

Next, the transmission timing of the pairing information by the VA-GA communication described above is specifically described. In the embodiment, when the time or the distance in accordance with the position of the vehicle 200 and the installation position of the electric power supply device 100 is less than a threshold value, a pairing signal is transmitted from the electric power reception device 210 to the electric power supply device 100, and the operation mode of the electric power reception device 210 is shifted to the electric power reception mode when a reply from the electric power supply device 100 to the pairing signal is obtained.

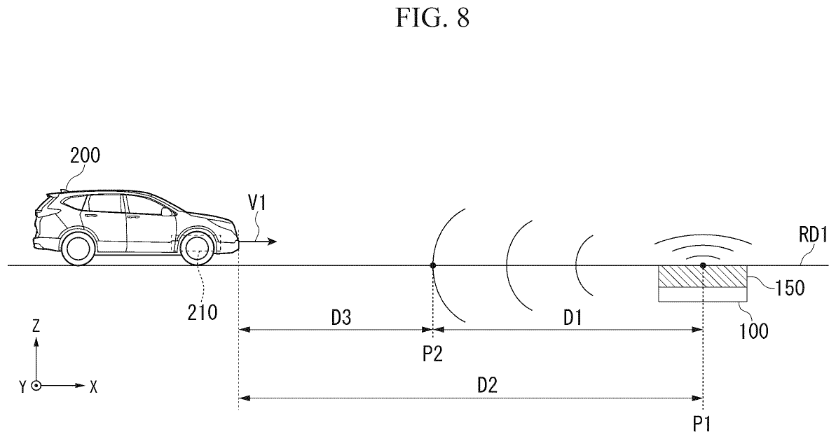

FIG. 8 is a view showing detection of the electric power supply device 100 provided on a road. In the example of FIG. 8, the electric power transmission device 110 is buried below a road RD1, and a position specifying member 150 for externally specifying the position of the electric power supply device 100 in the road region is provided above the electric power transmission device 110 (on the ground side). The position specifying member 150 is, for example, a member that allows (does not block) a signal (radio wave) from the electric power supply device 100 and a signal to the electric power supply device 100 to pass through the position specifying member 150 and is also a cover member (lid portion) that absorbs an impact (load) on the electric power supply device 100. Further, at least an upper surface of the position specifying member 150 is formed with a color different from the color of the road surface (or is applied with a different color) so that the position of the electric power supply device 100 can be specified from an analysis result of a camera image captured by the camera of the detection device 240. The shape and the size of the position specifying member 150 are not limited to the example of FIG. 8.

For example, the position detection portion 217 refers to the map information and detects a position corresponding to the electric power supply device 100 (or the electric power transmission device 110) around the vehicle 200 (within a predetermined distance) on the basis of the position information acquired by the vehicle sensor 250. The position corresponding to the electric power supply device 100 may be, for example, a center position P1 of the electric power supply device 100 or may be a position of the nearest end portion when seen from the vehicle 200. Further, the position corresponding to the electric power supply device 100 may be a position P2 that is predicted to be capable of performing communication by the electric power supply side communication portion 130 or performing electric power supply from the electric power supply device 100. The position P2 is a position in front of the position P1 when seen from the vehicle 200. The position P2 is, for example, a position where the coupling coefficient (coupling degree) in the magnetic field coupling is equal to or more than a threshold value (for example, the coupling coefficient is about 0.003); however, the position P2 is not limited thereto and may be a positon in front of the position P1 (vehicle 200 side) by a predetermined distance D1.

The communication control portion 216 acquires, based on the position and the traveling direction of the vehicle 200, a distance D2 between the vehicle 200 and the position Pl corresponding to the electric power supply device 100 present in the traveling direction and transmits a pairing signal when the acquired distance D2 is less than a predetermined distance. Further, the communication control portion 216 may acquire, instead of the position P1, a distance D3 between the position P2 and the vehicle 200 and may transmit a pairing signal when the vehicle 200 arrives in the distance D3. Thereby, since the pairing signal is transmitted at an appropriate timing when there is a high possibility that the reply to the pairing signal is obtained from the electric power supply device 100, it is possible to further efficiently communicate with the electric power supply device 100.

Further, the communication control portion 216 may control the timing of transmitting the pairing signal based on time information instead of the distance information (distance D2, D3). In this case, the communication control portion 216 calculates, based on the current position and the speed V1 of the vehicle 200, a time until the vehicle 200 arrives at a position (for example, the position P1) associated with the electric power supply device 100 and transmits the pairing signal when the calculated time is less than a predetermined time. The predetermined time may be a time when it is predicted that the vehicle 200 arrives at the position P2 when the speed V1 of the vehicle 200 is assumed to be constant or may be a fixation time. Further, the communication control portion 216 may calculate the time until the vehicle 200 arrives at the position P2 associated with the electric power supply device 100 and may transmit a pairing signal at a timing when the calculated time elapses. Further, the position detection portion 217 may perform a known image analysis process (for example, an edge extraction process, feature quantity extraction, a pattern matching process, or the like) on the camera image captured by the camera instead of (or in addition to) the calculation of the distance to the electric power supply device 100 using the position of the vehicle 200 and the map information described above and may acquire a position corresponding to the electric power supply device 100 present in the traveling direction of the vehicle 200 on the basis of the analysis result. In this case, the detection device 240 detects the position of the electric power supply device 100 from the position of the position specifying member 150 obtained from the analysis result of the camera image captured by the camera, a road sign, a character or a mark drawn on the road, and the like. Since the position detection portion 217 can further accurately acquire the position corresponding to the electric power supply device 100 by performing both the acquisition of the position of the electric power supply device 100 based on the map information and the acquisition of the position of the electric power supply device 100 based on the analysis result of the camera image of the camera, it is possible to transmit the pairing signal at a further appropriate timing, and it is possible to realize a further efficient communication.

The position detection portion 217 detects the position of the electric power supply device 100 by using both the map information and the camera image, for example, when the speed V1 of the vehicle 200 is less than the predetermined speed since a time until the vehicle 200 arrives at the electric power supply device 100 can be ensured, and detects the position of the electric power supply device 100 by using one of the map information and the camera image when the speed V1 is equal to or larger than the predetermined speed. Further, in the case where it is expected that it is difficult to detect the position specifying member 150 by the camera image such as the case of rain on the basis of the weather and the illuminance around the vehicle 200, the position detection portion 217 may detect the position of the electric power supply device 100 by using only the map information. In this way, it is possible to further appropriately detect the position of the electric power supply device 100 in accordance with the situation of the vehicle 200.

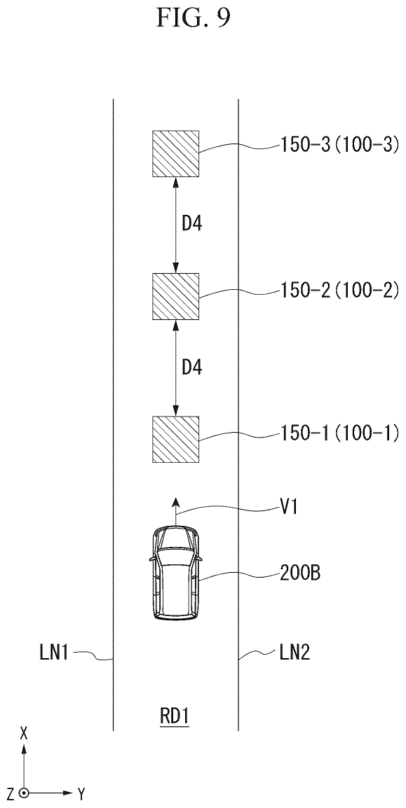

Further, when a plurality of electric power supply devices 100 are arranged, the position detection portion 217 may detect the zone. FIG. 9 is a view showing a state in which a plurality of electric power supply devices 100 are arranged. In the example of FIG. 9, a vehicle 200B is traveling in a traveling direction (the X-axis direction in the drawing) on a road RD1 partitioned by road partition lines LN1, LN2 at a speed V1. Further, a plurality of position specifying members 150-1 to 150-3 are arranged on the road RD1 at a predetermined distance D4 along the extension direction of the road RD1. The electric power supply devices 100-1 to 100-3 are buried below the plurality of position specifying members 150-1 to 150-3, respectively.

For example, when the predetermined interval D4 is less than a predetermined interval, the position detection portion 217 regards the electric power supply devices 100-1 to 100-3 as one electric power supply device and performs detection. The communication control portion 216 controls the timing of starting transmission of the pairing signal in the electric power supply zone based on the detection result with reference to the position of the nearest electric power supply device 100-1 among the electric power supply devices 100-1 to 100-3. Thereby, it is possible to transmit the pairing signal at a further appropriate timing.

### Process Flow

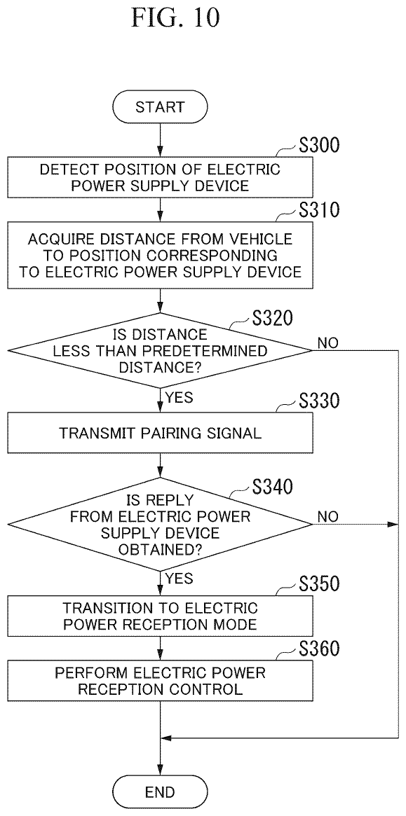

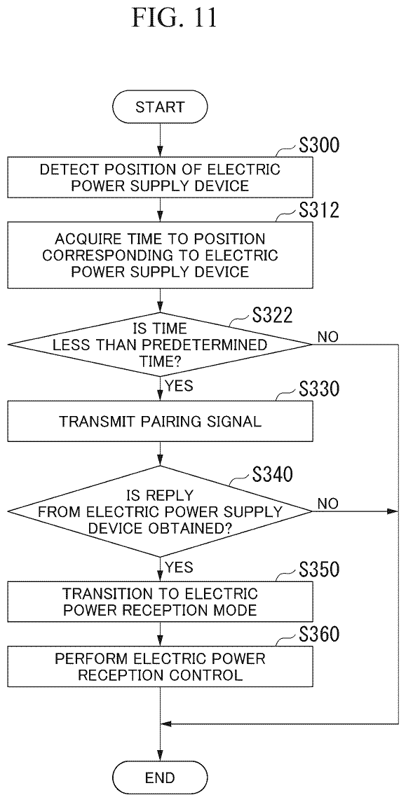

FIG. 10 is a flowchart showing another example (part 1) of a contactless electric power transmission process. The process of FIG. 10 relates to another example of the process shown in FIG. 7 described above of transmitting the pairing information and performing an electric power reception control after the pairing. The processes of FIG. 10 and FIG. 11 described later may be repeatedly performed at a predetermined timing. In the example of FIG. 10, the position detection portion 217 detects the position of the electric power supply device 100 that is present in the traveling direction of the vehicle 200 (Step S300). Next, the position detection portion 217 acquires a distance from the present position of the vehicle 200 to the position associated with the electric power supply device 100 (Step S310). Next, the communication control portion 216 determines whether or not the acquired distance is less than a predetermined distance (Step S320). When it is determined that the acquired distance is less than the predetermined distance, the communication control portion 216 causes the vehicle side communication portion 230 of the vehicle 200 to transmit a pairing signal (Step S330). Next, the communication control portion 216 determines whether or not a reply from the electric power supply device 100 to the pairing signal is obtained (Step S340). When it is determined that the reply is obtained, the communication control portion 216 shifts the operation mode of the electric power reception device 210 from the standby mode to the electric power reception mode (Step S350) and performs a control (charging control) for receiving electric power (Step S360). Thereby, the process of the present flowchart ends. Further, when it is determined that the distance is not less than the predetermined distance in the process of Step S320 or when the reply from the electric power supply device 100 is not received even after a predetermined time elapses in the process of Step S340, the process of the present flowchart ends.

FIG. 11 is a flowchart showing another example (part 2) of a contactless electric power transmission process. The process of FIG. 11 has processes of Step S312 and Step S322 instead of the processes of Step S310 and Step S320 compared to the processes of Steps S300 to S360 shown in FIG. 10. Accordingly, in the following description, the processes of Step S312 and Step S322 are mainly described. In the example of FIG. 11, after the process of Step S310, the position detection portion 217 acquires an arrival time to the position corresponding to the electric power supply device 100 on the basis of the present position and the speed V1 of the vehicle 200 (Step S312). Next, the position detection portion 217 determines whether or not the recognized time is less than a predetermined time (Step S322). When it is determined that the recognized time is less than the predetermined time, the communication control portion 216 causes a pairing signal to be transmitted from the vehicle side communication portion 230 of the vehicle 200 (Step S330) and performs subsequent processes. Further, when it is determined in the process of Step S322 that the recognized time is not less than the predetermined time or when a reply from the electric power supply device 100 is not obtained after the predetermined time elapses, the process of the present flowchart ends.

According to the embodiment described above, the contactless electric power transmission system supplies electric power in a contactless manner from the electric power supply device 100 provided on the movement path of the vehicle 200 (an example of a movable body) to the electric power reception device 210 provided on the vehicle 200, wherein the electric power reception device 210 includes the communication control portion 216 that transmits the pairing signal from the electric power reception device 210 to the electric power supply device when the time or the distance in accordance with the position of the vehicle 200 and the installation position of the electric power supply device 100 is less than a threshold value and shifts the operation mode of the electric power reception device 210 to the electric power reception mode when a reply to the pairing signal from the electric power supply device 100 is obtained. Thereby, it is possible to perform further appropriate electric power transmission even when the vehicle 200 is moving.

Further, according to the embodiment, it is possible to reliably perform pairing at a higher speed. Further, according to the embodiment, by adjusting the transmission timing of the pairing signal from the electric power reception device 210, it is possible to reduce electric power consumption related to the transmission of the pairing signal. When using the weak magnetic field coupling, the timing of the transmission from the VA side is critical. For example, when the distance between the electric power reception device 210 and the electric power supply device 100 is too large, since the devices are not coupled, it is impossible to transmit information, and wasteful electric power consumption occurs. Further, when the distance is too small, the device enters an electric power transmission range before completing the pairing, and the loss of a charging opportunity occurs. Therefore, in the embodiment, by further accurately detecting the position of the GA side using a camera or the like, calculating the transmission timing, and transmitting a pairing signal from the VA side, it is possible reduce electric power consumption and realize efficient pairing communication.

### Modification Example

For example, as a modification example of the embodiment, the electric power reception device 210 of the vehicle 200 may transmit pairing information from the electric power reception device 210 (vehicle 200) to the electric power supply device 100 when being in a weak coupling state coupled with the electric power supply device 100 by a weak magnetic field in a predetermined range and when the time or the distance in accordance with the position of the vehicle 200 and the position corresponding to the installation position of the electric power supply device 100 is less than a threshold value. Further, as a modification example of the embodiment, for example, the vehicle 200 may not include the vehicle side communication portion 230. In this case, the communication control portion 216 transmits pairing information from the electric power reception device 210 to the electric power supply device 100 when the time or the distance in accordance with the position of the vehicle 200 and the installation position of the electric power supply device 100 is less than a threshold value and when being in a weak coupling state coupled with the electric power supply device 100 by a weak magnetic field in a predetermined range.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A contactless electric power transmission system that supplies electric power in a contactless manner from an electric power supply device provided on a movement path of a movable body to an electric power reception device provided on the movable body,
wherein the electric power reception device comprises:
a control portion that transmits a pairing signal to the electric power supply device from the electric power reception device when a time or a distance in accordance with a position of the movable body and an installation position of the electric power supply device is less than a threshold value, and shifts an operation mode of the electric power reception device to an electric power reception mode when a reply to the pairing signal from the electric power supply device is obtained.

2. The contactless electric power transmission system according to claim 1, further comprising:
a position detection portion that detects a position of the electric power supply device which is present in a traveling direction of the movable body based on the position of the movable body and map information and/or detects the position of the electric power supply device based on an analysis result of an image captured by a camera mounted on the movable body,
wherein the control portion transmits the pairing signal when a distance to the position corresponding to the installation position of the electric power supply device detected by the position detection portion is less than a predetermined distance.

3. The contactless electric power transmission system according to claim 1, further comprising:
a position detection portion that detects a position of the electric power supply device which is present in a traveling direction of the movable body based on the position of the movable body and map information and/or detects the position of the electric power supply device based on an analysis result of an image captured by a camera mounted on the movable body,
wherein the control portion transmits the pairing signal when a time until the movable body arrives at the electric power supply device detected by the position detection portion is less than a predetermined time.

4. The contactless electric power transmission system according to claim 1,
wherein the control portion transmits the pairing signal from the electric power reception device to the electric power supply device when being in a weak coupling state coupled with the electric power supply device by a weak magnetic field in a predetermined range.

5. A movable body on which an electric power reception device that receives electric power in a contactless manner from an electric power supply device provided on a movement path is mounted, the movable body comprising:
a control portion that transmits a pairing signal to the electric power supply device from the electric power reception device when a time or a distance in accordance with a position of the movable body and an installation position of the electric power supply device is less than a threshold value, and shifts an operation mode of the electric power reception device to an electric power reception mode when a reply to the pairing signal from the electric power supply device is obtained.

6. A contactless electric power transmission method that supplies electric power in a contactless manner from an electric power supply device provided on a movement path of a movable body to an electric power reception device provided on the movable body, the contactless electric power transmission method comprising:
by way of the electric power reception device, transmitting a pairing signal to the electric power supply device from the electric power reception device when a time or a distance in accordance with a position of the movable body and an installation position of the electric power supply device is less than a threshold value; and
shifting an operation mode of the electric power reception device to an electric power reception mode when a reply to the pairing signal from the electric power supply device is obtained.
